(19) United States
(12) Patent Application Publication
(10) Pub. No.: US 2008/0050713 A1
(43) Pub. Date: Feb. 28, 2008

(54) System for submitting performance data to a feedback community determinative of an outcome

(76) Inventor: Narbeh AVEDISSIAN, Studio City, CA (US)

Correspondence Address: DALINA LAW GROUP, P.C., 7910 IVANHOE AVE. #325, LA JOLLA, CA, 92037, US

(21) Appl. No.: 11/549,027

(22) Filed: Oct. 12, 2006

Related U.S. Application Data
(60) Provisional application No. 60/836,465, filed on Aug. 8, 2006.

(51) Int. Cl. G09B 3/00

(52) U.S. Cl. 434/350

(57) ABSTRACT

Uses a telecommunications device/computer as an open microphone for collecting media, for example audio, video or text performances that are then integrated into an online community for feedback/judging. The media may include singing, instrumental music, rhythmic music, videos, writings. The performances may also be made available as ring tones. Allows for a server to accept a call/IP connection from an artist, accept payment for a number of recording minutes, provide a genre list (e.g., singing, band, DJ, beat makers), accept selection of a genre and record a performance. Furthermore, the server may also be configured to play, transfer or email a performance, for example as directed from a website or telecommunications device. The media may be judged and/or ranked by members of the community. Recording time may be monitored and a charge levied for submission of the performance. Server may play, download or email the performance.

This application takes benefit from U.S. Provisional Patent Application Ser. No. 60/836,465, filed Aug. 8, 2006, the specification of which is hereby incorporated herein by reference.

### BACKGROUND OF THE INVENTION

1. Field of the Invention

The invention relates to the field of computer software and is more particularly, but not by way of limitation, directed to a system and method for obtaining and synchronizing artist data with an online community and submitting performance data to a feedback community to decide an outcome.

2. Description of the Related Art

There are numerous online communities that provide users with an interface for interacting with other users. These online communities are generally referred to as “social networks.” Some examples of early web based social networks include websites such as classmates.com and sixdegrees.com. Around 2001, other networks began to emerge that made use of an approach know as the “circle of friends” model. This form of social networking became particularly popular with the advent of websites such as friendster.com and myspace.com that allow users to establish a select group with whom they interact with about numerous topics. Setting up a community within a website that uses a circle of friends model is accomplished by having an initial set of founders invite members of their own personal networks to join the community. New members repeat the process thereby steadily increasing the number of members and links. Users that belong to the community are able to use features that provide them with increased functionality.

In some cases, online social networking is combined with offline elements such as face-to-face events. MySpace, for example, builds on independent music and party scenes. The newest social networks on the Internet are becoming more focused on niches such as art, tennis, football (soccer), golf, cars, dog owners, and even cosmetic surgery. Although the existing social networks are powerful tools for interacting with people who have similar interests, such communities are not organized to provide collective input about other users with the goal being to elevate one or more users to a status that yields real life business implications. In areas where users hold themselves out as having artistic talent, there is a need for such an ability to convert feedback obtained from the online community into real world benefits.

### BRIEF SUMMARY OF THE INVENTION

One or more embodiments of the invention are directed to a system and method for obtaining and synchronizing performance data with an online feedback community determinative of the outcome. The general methodology involves obtaining information about an artist and obtaining performance data associated with the artist. Once obtained this performance data is then exposed to the community for feedback in a manner that is determinative of the outcome associated with a particular artist. Artist information generally takes the form of a profile that contains personal information about the artist or a group of artists (hereinafter “artist”) whereas the performance data is a media file (e.g., audio, video, and/or text or any combination thereof) that is provided by the artist or a person(s) submitting on behalf of the artist. Once an artist's performance data is submitted the artist may be subject to feedback and judging from at least one person designated with such responsibility. In at least one embodiment of the invention participants in the community have access to an ongoing talent competition where contestants submit their initial entry (e.g., performance data) via a wireless or wired telecommunications device such as a telephone or computer. Once submitted, an artist's performance data is synchronized into the online community and associated with the artist's profile data. The online community is then prompted for feedback about the performance and a decision is made about what offers to extend to the artist based on the feedback.

At least one of the goals in accepting telephone submissions or online video submissions is to enable easy entry into the community due to the ubiquity of the telephone or computers and to provide for inexpensive competition entry. As compared to most talent contests there are minimal constraints placed on the entrants in terms of what is a reasonable or appropriate submission to the community for consideration. Certain exceptions however are possible based on legal considerations or other factors such as a lack of popularity or violation of a terms of use agreement. The invention also enables the community to control a performance's rise in popularity. Submitted performance data is optionally made available as ring tone data or a general media file that can be downloaded into a cell phone or other computation device where use of such files might be applicable. Users can, for example, purchase personalized ring tones or other data for download into one or more mobile telephones.

The Contest or Audition:

One or more embodiments of the invention are directed towards facilitating a competitive process that artists participate in via a telecommunications device such as a telephone or computer configured with an audio and/or video and/or text interface. The telecommunications device serves as an open input mechanism for collecting media, for example audio, video or text performances that are then integrated into an online community for feedback by the community. Audio data for example may include singing, instrumental music or rhythmic music. Performances are also available as ring tones, video data or multimedia data for purchase. To obtain performance data from the artists, one or more embodiments of the invention enable a server to accept input such as a call or video stream from an artist. The system may optionally accept payment for a number of recording or submission minutes. In such cases the charge may be associated with the type and/or length of performance data submitted. Submitted performance data is optionally associated with a defined genre list (e.g., singing, band, DJ, beat makers) and users may accept selection of a genre and opt to submit performance data within that specific genre. Furthermore, the server may also be configured to play, transfer or email performance data, for example as directed from a website or telecommunications device. The recorded performance data may comprise any form of media and may be entered into the community for consideration by community participants (e.g., judges and/or members of the community itself).

The community participants are able to rate each performance and optionally provide feedback about the performance. Performance data submitted to the community for consideration is ranked and results can be determined by conducting an assessment of the rankings. Various ranking criteria are considered within the scope and spirit of the invention and adjustments to the rankings may be made to account for possible inaccuracies. In at least one embodiment of the invention each member of the community is permitted to cast a single vote for each item of performance data associated with the community. In other cases the system is configured to enable members to vote multiple times about multiple aspects of a performance and/or change the ranking given to a particular performance over time. Hence the popularity of a particular performance may rise and fall over time based on the ongoing feedback provided by the community. Members of the community may be given an associated ranking power that gives a greater ability for some users to influence the outcome. Feedback from members of the community designated as judges or trend-spotters may for instance have a higher ability to influence a ranking. Community members may also gain a greater ranking power over time as the number of rankings submitted increases. Hence a member who submits only one vote may not be taken into account as much as a member who has submitted numerous votes. Alternatively but not by way of limitation a users first vote may have a greater weight than subsequent votes. Some members of the community may have a greater weight within a certain genre (e.g., rock music) and a lower weight within other genres (e.g., country music).

Various mechanisms for obtaining media/performance data are contemplated as being within the scope of the invention and artists may also elect to use alternative paths for interacting with an embodiment of the invention by for example calling the toll-free phone number or recording and uploading video to the community. Artists may submit performance data to the system by uploading a media file such as video or audio data to the community for consideration. Submission of performance data via an IP telephony system such as Skype® or Vonage® is also feasible. In one or more embodiments of the invention recording time is monitored and a charge may be levied for making the submission or the performance. Users may, for instance, record a performance via Skype® and save the performance into their artist profile. Once the artist approves the performance, the recording of the performance is uploaded by the server to the caller's unique online personal profile as an audio file such as an MP3 or any other type of portable audio file. The artist may direct the server to then play, download or email their recording (video, audio, or other media) from their personal page within the online community. VOIP technology may be used to record the performance data and software integrated with the system is configured to process the recorded performance data and make it available to the community where it becomes subject to review and reward. In at least one embodiment of the invention the artist(s) associated with the performance data selected by the community within a defined period of time is rewarded with a record contract from a record label affiliated with the community through a formal business relationship. Hence at periodic intervals determined by an administrator or other authorized person of the community, record contracts are awarded to the artist having been elected or ranked by the community as best within a specific genre. The awards that are given to the artists may differ by genre and in at least one case may entail forms of compensation other than a record contract.

Performance Data for Purchase:

Performance data submitted to the community for consideration can optionally be made available to members of the community and others as ring tones. Hence artists can use the system to generate performance data that is processed by the system and uploaded so that it becomes available for purchase as a ring tone. In the instance where the performance data is video user may upload the video data for purchase via the Internet. Users may also create customized ring tones using the system for obtaining audio data described herein and then purchase the ring tone via an online purchasing interface. In cases where the system for obtaining media data or performance data is separate from the purchasing system submitted data can be synchronized with the purchasing system so that it becomes accessible.

Community:

In one or more embodiments of the invention the artist community is configured to offer a feature whereby artists may: 1) visit other profiles, and listen to, or in the event they have uploaded a video to watch, other artists performances and invite them to have a “Jam Session” (basically an invitation to play music together for fun), “Join My Band” or “Let's Start a Band.” The community also contains a section dedicated to artists actively seeking to find new band members or start a new band. Artists within the community may be grouped by genre and each genre features personal profiles or artists who have uploaded their music for other musicians and the community to audition and rank.

### BRIEF DESCRIPTION OF THE DRAWINGS

The above and other aspects, features and advantages of the invention will be more apparent from the following more particular description thereof, presented in conjunction with the following drawings wherein:

FIG. 1 is a flow diagram that illustrates how registered users are routed for purposes of obtaining performance data in accordance with one or more embodiments of the invention.

FIG. 2 is a flow diagram that illustrates how unregistered users are routed for purposes of obtaining performance data in accordance with one or more embodiments of the invention.

FIG. 3 is a flow diagram that illustrates the registration process as it is conducted via an online global computer network.

FIG. 4 is a flow diagram that shows the actions provided by the system with respect to performances recorded with embodiments of the invention.

FIG. 5 is a system architecture diagram.

### DETAILED DESCRIPTION OF THE INVENTION

One or more embodiments of the invention are directed to a system and method for obtaining performance data and determining an outcome based on feedback from an online community. The description set forth herein is exemplary, rather than limiting, and many variations and modifications are within the scope and spirit of the invention. Although numerous specific details are set forth in order to provide a thorough understanding of the present invention, it will be apparent to one of ordinary skill in the art, that embodiments of the invention may be practiced without these specific details. In other instances, well-known features have not been described in detail in order to avoid unnecessarily obscuring the present invention.

The general methodology for obtaining and synchronizing performance data involves obtaining information about an artist and obtaining performance data associated with the artist. The term performance data refers to any artistic performance captured within a tangible medium such as computer memory. Such performances are typically recorded in audio or video form prior to or simultaneous with submission to the community. Although the example given here is discussed in the context of a musical performance readers should note that embodiments of the invention are equally applicable to other types of performances such as acting performances, dancing performances, video performances or works of art such as drawings, paintings or other visual renditions made by an artist.

Information related to the artist may be obtained in any manner including via telephonic communication or website based communication. Likewise, media such as performance data may be obtained over a telecommunication medium including a wireless or wire based telephone channel, or over an Internet based telephone channel for example. When an artist's performance is captured in video form that video and the accompanying audio data may be uploaded to the community for determination as to the popularity of the performance data.

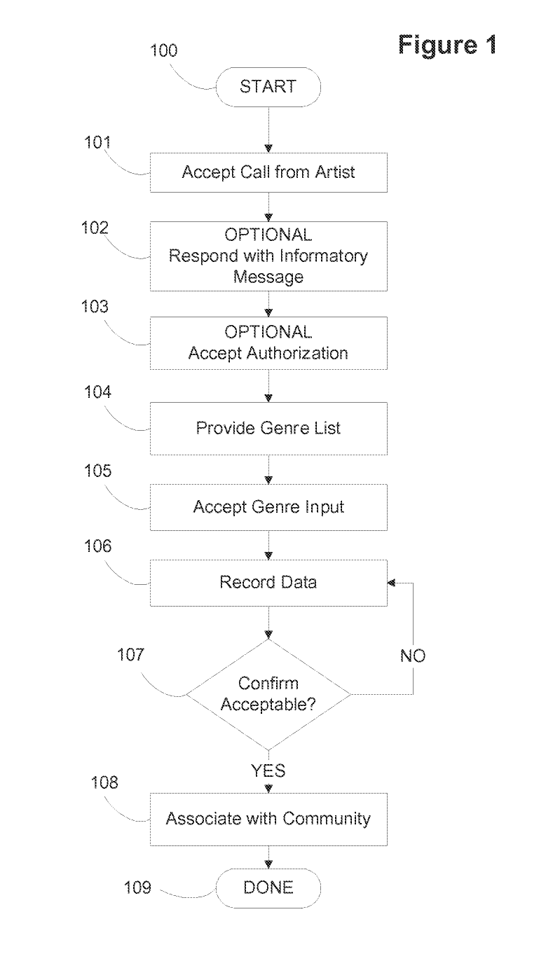

FIG. 1 is a flow diagram that illustrates how registered users are routed for purposes of obtaining artist related information and performance data in accordance with one or more embodiments of the invention. Processing begins at 100. For a pre-registered user, the artist calls a phone number and the system accepts a call at step 101. At least one of the goals in accepting telephone submissions is to enable artists to have a simplified mechanism for auditioning for a record contract or other reward. It is also feasible and considered within the scope of the invention to accept video submission. As compared to most contests or auditions there are minimal constraints placed on the entrants in terms of what is an acceptable submission. The community rankings and feedback mechanisms discussed later below act as a natural filter for bad or inappropriate content as such content is likely to have a diminished popularity over time. Any method of accepting a audio or video data including a computer, electronic telephone exchanges or use of Internet Protocol based connections is in keeping with the spirit of the invention. For instance, a computer configured to enable the capture and upload of audio or video data to the community acts to accomplish the goal of providing such data to the community for further evaluation.

In the telephone based embodiment discussed at FIG. 1, the system optionally responds with an automatic message at 102. The message may include marketing information or information related to a contest for example. In one embodiment, an automated voice greets the artist: “Welcome to “service name”, where stardom is a phone call away. “Service name” will announce a winner from each genre at the end of the season. The winners will get a cash prize and an opportunity to get signed with a record label or company that agrees to distribute the artists performance data. Go to www.“website name”.com for details. Please punch in your personal membership number to get started.” In this example, “service name” is the name of the entity or service offering the contest and “website name” is the name of the website to traverse for information related to the contest.

The system may optionally accept an authorization token, for example a cookie, PIN, password, user identification, certificate, or any other method of authenticating the user at 103. Any method of authorizing a user including use of IP address or incoming phone number or caller ID is in keeping with the spirit of the invention.

The system provides a genre list at 104. For example, the system may include “pop”, “rock”, or any other genres that may be associated with a contest. Certain contests may only include genres that make sense for the particular contest. For example a contest targeted at a particular segment of participants would only include genres that the targeted segment was interested in. In this case a group of participants that may be directed at a group of closely related sub-genres. For example, a contest directed at the rock and pop segment may include genres of alternative, disco, emo, gothic, indie, lounge, metal, new wave, progressive, punk, ska and surf rock.

The system then accepts a genre input at 105. Any type of input that the system interprets as a selection for a given genre item is in keeping with the spirit of the invention including but not limited to a key press, a voice indication or any other assertion that a particular genre is desired. Optionally, the system may respond with an informatory message (not shown in FIG. 1), such as “You've selected “genre X”, if this is correct press 1, if not press 2. Great. Now get ready to lay down your sound on “service name”. You may begin after the beep and stop your session by punching the pound key at any time. Hey, but don't forget to play back your performance before confirming your submission. And you don't want to forget to view your ranking at www.“website name”.com.”

The system prompts for example to alert a user that the system is recording input/transferring data and records data at 106. In telephonic embodiments, a prompt such as a beep may be utilized to signify that recording has started. The optional informatory message in the previous step may be followed by a prompt such as “with some applause in the background, “service name” is proud to present tonight's performer” . . . beep. In other embodiments, such as computer embodiments, a graphical or visual display may be utilized to signify that the recording has started or is about to start, e.g., a count down timer. A wide variety of media performances is possible since performances that include or mimic copyrighted media may be marked as not available for sale.

The system may provide a confirmation prompt and accept confirmation input at 107. Confirmation allows a user to confirm that the performance meets the user's expectations. If the recording is unacceptable to the artist, recording occurs again at 106. The system may provide any type of confirmation prompt to the user including visual or audio based prompts. A verbal prompt for example may be utilized in a telephonic or computer based embodiment to query the user for recording confirmation. In one embodiment of the invention, the system may utilize a prompt such as “Play back your session to see if it was good enough to get you signed by pressing 1 now. Once the performance is replayed, “Please press 1 to erase and re-record (they will be notified if they are out of minutes and given instructions to buy more minutes), or press 9 to make your submission.” In one or more embodiments of the invention steps 101 through 103 are bypassed and performance data is submitted directly to the online community, via video and/or audio upload, for review in the relevant genre. In cases, for instance, where an artistic performance is captured in audio and/or video form the media file may be uploaded to the community via the Internet without the need to perform the steps which involve the telephone.

Once an artist's performance is accepted, an artist's performance data is synchronized into the online community and associated with the artist's profile data at 108. The online community may be alerted to the new arrival in any manner including subscription based syndication such as a podcast for example via RSS or Atom. Processing ends at 109.

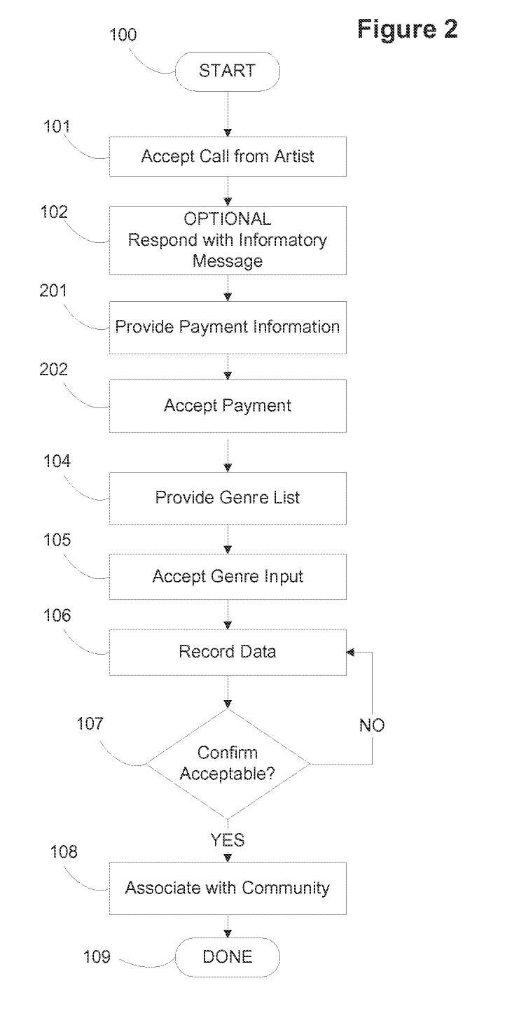

FIG. 2 is a flow diagram that illustrates how unregistered users are routed for purposes of obtaining performance data in accordance with one or more embodiments of the invention. Processing is similar to that of FIG. 1 and as such identical reference numbers may be referred to in reference to FIG. 1 above. In addition to the accept call, and optional informatory message delivery, payment information is optionally provided by the system at 201 so that an artist may decide how to pay for use of the system. Payment information may include the types of credit cards or online payment services that may be utilized to pay for recording time. In one embodiment of the invention the system provides payment information such as “99 cents per minute is all it costs to start your personal session and have a chance at winning a cash prize and most importantly getting signed.” “You may buy as many minutes as you feel you need to lay down your sound. 99 cents per minute or buy one of our bundles. For $5 you get 7 minutes or for $10 you get 15 minutes. For 7 min press 1, for 15 min press 2 or for 1 min press 5.” “You may use Visa®, Mastercard® or Discover Card® to purchase your minutes.” The system may also be configured to obtain payment from an artist before performance data such as audio and/or video data is uploaded to the community. In other cases the upload is free of charge and no payment is required. Embodiments of the invention are also contemplated where the telephone input is also free of charge although there is no requirement that access to the telephone input mechanism be offered free of charge.

The system optionally accepts payment at 202. This may include any type of payment mechanism such as a credit card backend processing methodology or acceptance of an online payment electronically. Any method of accepting payment is in keeping with the spirit of the invention.

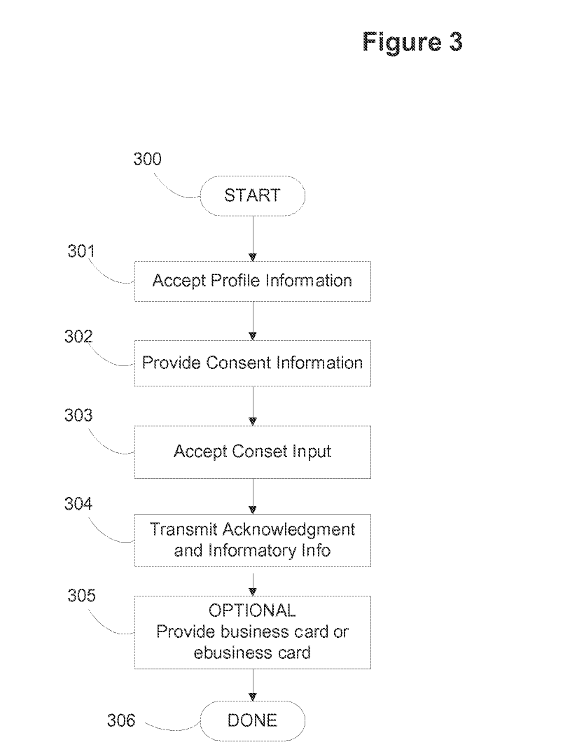

FIG. 3 is a flow diagram that illustrates the registration process as it is conducted via an online global computer network. Processing starts at 300. When an artist visits the server based artist community exemplified in one or more embodiments of the invention, artist registers at 301. In one embodiment of the invention this includes accepting profile information from the artist such as the artists name, email address(s), physical address, phone number(s), gender, age, interests, and authentication information. More or less of this profile information about the artist may be obtained by the system as one skilled in the art will recognize. If the user has already recorded a performance, the authentication information may be utilized to synchronize the recording previously performed with the online profile. Otherwise the recording will synchronize with the online profile after recording if the online registration processes occurs before the telephonic registration process.

Consent information is provided at 302. The consent information may be in the form of a preselected checkbox and informatory message in one embodiment of the invention. For example, the box advises artists they will receive updates on their performance, via email or text message, from judges and a newsletter giving them underground industry information (e.g., best places to get noticed). The informatory message includes terms and conditions under which the artist consents to receive information (via email, mobile etc.) and also provides terms and conditions under which participation in the community is acceptable.

Consent input is accepted at 303 and may include a form submit, or JavaScript® or applet based assertion to the server that consent is given or not. Any method of accepting input from the user to determine the user's consent is in keeping with the spirit of the invention.

The system transmits an acknowledgment and informatory information to the artist at 304. In one embodiment of the invention, this may be in the form of a message such as “thank you for joining the premier online community for artists” and the system may provide confirmation of the artist's registration along with their authentication information and an explanation of how to create and personalize their online profile and how to best utilize the website for self-promotion.

Optionally, a business card graphic or electronic business card or e-card may be provided to the artist for the purpose of promotion. The promotional e-card may be emailed or printed as a business card to market themselves and the service provider providing the online community and contest. The card may promote an embodiment of the system and contain information unique to the artist, e.g., “visit my profile at “website name”.com” or “hear me on “website name”.com.” Processing ends at 306.

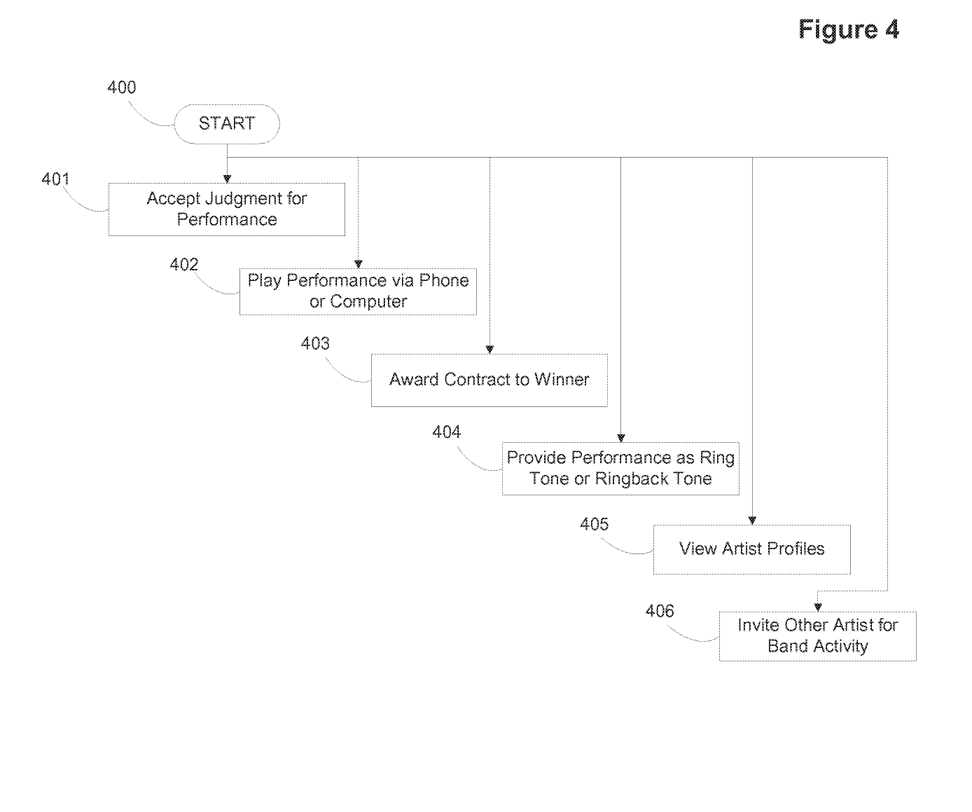

FIG. 4 is a flow diagram that shows the actions provided by the system with respect to performances recorded with embodiments of the invention. The artist may be subject to feedback and judging from the community or at least one person designated with such responsibility at 401, for example a teacher or panel of judges. A celebrity may in one or more embodiments, be responsible for providing feedback to an artist. The feedback may result in a particular performance climbing a chart or being positioned higher upon a list of performances for example.

The system enables artists to visit other profiles and listen to, (or in the event they have uploaded a video watch), other artists performances. For example, the system may play, transfer or email a performance to another person at 402. Playing a performance may include streaming the performance or playing the performance over a telecommunications link or Internet Protocol link for example. Likewise, the performance may be emailed, or a link to the performance may alternatively be emailed to a desired user.

In at least one embodiment of the invention the artist(s) that the community determines is most popular is rewarded with a record contract from a record label affiliated with the community through a formal business relationship at 403. After a contest is concluded, embodiments of the system may transmit an award notification for example to alert the winning artist of the final result of the contest.

The system may also provide the performance as a ring tone or ringback tone at 404. Users that call into the system can, for example, purchase personalized ring tones for download into their mobile telephones or ringback tones for use as ring sounds when another user is calling the artist. For ringback tones, interfacing with a telephone entity allows for playback of a performance to another user's phone for example when that user is waiting for the artist to pick up. Hence whenever another user calls the artist, they hear the artist's performance.

The system enables a user to invite another user to band related activity at 406. The band related activity may include a “Jam Session” for example. A “Jam Session” is basically an invitation to play music together for fun. The system also allows for other band related requests to other artists such as “Join My Band” and “Let's Start a Band”. Artists within the community may be grouped by genre and each genre features the personal profiles of artists who have uploaded their music for other musicians and the community to audition and rank. In this manner, the system allows for band related activities to be performed between artists on a genre basis if desired. Embodiments of the invention allow an individual to effectively audition an artist by watching or listening to their performance prior to performing a band related request which is heretofore impossible using standard classified ads. If there is an interest in a particular performance the user can use the system to extend and invite for a live in person audition. In cases where the initial introductions are made through the system and an actual band or performance group is established as a result of such an introduction, the operator of the system may require or optionally be paid an ongoing management fee for the group of performers.

In one embodiment of the invention the community contains a performance room where other members of the community can simply watch a performance and then request the artist responsible for the performance participate in a collaborative session. The performance data from these collaborative sessions can be posted to the community and users may follow the path of an artist as he collaborates on different performances.

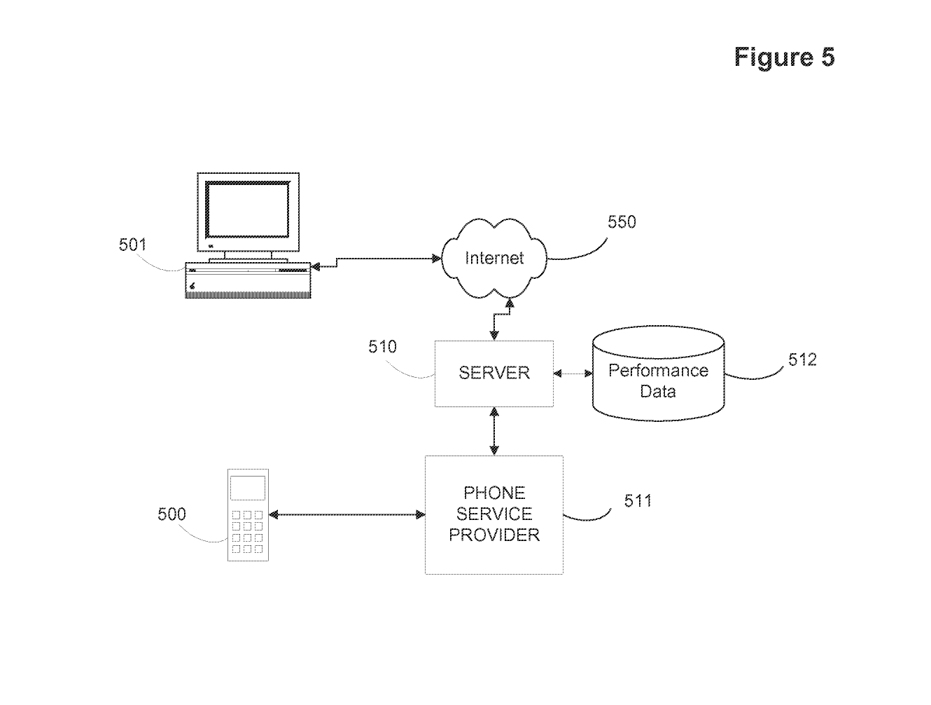

FIG. 5 is a system architecture diagram. Media input device is any device configured to obtain media data (audio and/or video) of a performance and provide such data to the system. Examples of media input devices include a computer telecommunications device 500 such as a mobile phone, wire based landline or any other type of telephone configured to transmit and receive media such as audio and/or video and/or text. Telecommunications device 500 may communicate directly with phone service provider 511. In some cases a telecommunications device may include Internet communications capabilities and may also communicate with server 500 via Internet 550. Computer 501 may include telecommunications software to allow access to users having telecommunications device 500 for example. In other cases computer 501 captures the performance data itself and provides such data directly to server 510 via Internet 550. Computer 501 may, for instance, be configured to obtain audio data and/or video data of a performance and provide the data to server 510 in the form of performance data. Performance data is stored on performance data repository 512. Server 500 may include an association module configured to obtain performance data from data repository 512. Any other component that is configured to obtain performance data from data repository may be utilized in embodiments of the invention including hardware, software or firmware based solutions. Any method of communicating between server 510 and phone service provider 511 is in keeping with the spirit of the invention, including voice over IP technology. Server 510 may include an interface with phone service provider 511 and may also include a web server for communicating via markup with computer 501. This system allows for registration over telecommunications device 500 and web registration and access of an online community hosted on server 510 using computer 501. Ring tones may be directly communicated to telecommunications device 500 by coupling telecommunications device 500 to computer 501 or by directly transmitting a ring tone over Internet Protocol from server 510 to telecommunications device 500 or by transmitting the ring tone via phone service provider 511. In addition, ringback tones may be transferred from server 510 to phone service provider 511 for use as an alternative to the standard two tone ringback tone used when waiting for a person to pick up, i.e., answer their phone. Embodiments of the invention that present performance data to a user can be implemented using any graphical user interface or web interface configured to obtain data from a server and present the data to a plurality of users. A judging interface may likewise be configured to use any graphical user interface or web interface for presenting and scoring a performance.

While the invention herein disclosed has been described by means of specific embodiments and applications thereof, numerous modifications and variations could be made thereto by those skilled in the art without departing from the scope of the invention set forth in the claims.

What is claimed is:

1. A system for providing performance data to an online community for outcome determinative feedback comprising:
a media input device for recording performance data from an artist;
a data repository for storing said recorded performance data;
a server configured to associate said performance data with a profile of said artist, present said performance data to an online community having access to said performance data, obtain feedback from at least one user with respect to said performance data, and announce a reward based on said feedback.

2. The system of claim 1 wherein said media input device comprises a telecommunications device.

3. The system of claim 1 wherein said media input device comprises a computer configured to capture said performance data.

4. The system of claim 1 wherein said performance data comprises audio data that reflects a performance made by said artist using said media input device.

5. The system of claim 1 wherein said artist comprises an individual.

6. The system of claim 1 wherein said artist comprises a group of individuals.

7. The system of claim 1 further comprising an association module configured to obtain said performance data from said data repository and make said data available to a server system comprising said online community.

8. The system of claim 1 wherein said online community comprises an interface for making said performance data available as ring tones.

9. The system of claim 1 wherein said online community comprises an interface for making said performance data available as ringback tones.

10. The system of claim 1 wherein said media input device is used to create customized ring tones that are subsequently made available for purchase.

11. The system of claim 1 further comprising a ranking system for determining which of said performance data is popular with said online community.

12. The system of claim 1 further comprising a judging interface for at least one judge to score said performance data.

13. The system of claim 12 wherein said artist with a highest score is given a record contract.

14. The system of claim 13 wherein said record contract is awarded based on a selection made by at least one judge.

15. The system of claim 1 configured to present an interface to said artist that permits said artist to review performance data submitted by other artists and extend an invite to said other artists in cases where said artist is interested in a live in person audition of said other artist.

16. The system of claim 1 wherein a management fee is collected when a group is formed by said invite.

17. A computer program product comprising computer readable instruction code executing in a tangible memory medium of a computer, said computer readable instruction code configured to:
obtain performance data from an artist from a media input device;
provide said performance data to a server supporting an online community accessible via a global computer network;
post scoring information about said performance data provided by members of said online community.

18. The computer program product of claim 17 wherein said computer readable instruction code is further configured to inform an artist with a highest score of a reward.

19. The computer program product of claim 17 wherein said performance data comprises video data.

20. The computer program product of claim 17 wherein said performance data comprises video data.

21. The computer program product of claim 17 wherein a fee is charged for obtaining said performance data from said artist.

22. The computer program product of claim 17 wherein said reward comprises a recording contract.

23. The computer program product of claim 17 wherein said computer readable instruction code obtains input about said performance data from members of said community.

24. The computer program product of claim 23 wherein said input is used to rank said performance data.

25. The computer program product of claim 23 wherein said input comprises a rating by members of said community.

26. The computer program product of claim 23 wherein said input comprises a rating by at least one judge of said performance data.

27. The computer program product of claim 23 wherein said performance data comprises personalized ring tones that are generated by personal recording or calling a telephone number and recording a personal ring tone that is then uploaded to personal profile for download via said server.
